(19) United States
(12) Patent Application Publication
(10) Pub. No.: US 2006/0136248 A1
(43) Pub. Date: Jun. 22, 2006

(54) Computer techniques for distributing information

(75) Inventors: Garth R. Hughes, Dallas, TX (US); Rhonda B. Johnson, Prosper, TX (US); William D. Brown, Grapevine, TX (US)

Correspondence Address: FULBRIGHT & JAWORSKI L.L.P., 600 CONGRESS AVE., SUITE 2400, AUSTIN, TX, 78701, US

(73) Assignee: Mary Kay Inc.

(21) Appl. No.: 11/117,663

(22) Filed: Apr. 28, 2005

Related U.S. Application Data
(60) Provisional application No. 60/637,926, filed on Dec. 21, 2004.

(51) Int. Cl. G06Q 99/00

(52) U.S. Cl. 705/1

(57) ABSTRACT

In a representative embodiment, a computerized method provides information to a user and allows electronic communication between the user and selected workers. A list of action items for selectable workers is provided, the listing of action items identifying actionable events according to a plurality of categories. A list of financial information for selectable workers is provided. A list of personal information for selectable workers is provided, and a pre-defined electronic communication from the user to selectable workers is generated based on the action items, financial information, or personal information.

This application claims priority to, and incorporates by reference, U.S. Provisional Patent Application Ser. No. 60/637,926, which was entitled, “Computer Techniques for Distributing Information” and which was filed Dec. 21, 2004.

### BACKGROUND OF THE INVENTION

1. Field of the Invention

The present invention relates to techniques for distributing information via computer to and among persons. More particularly, it concerns software, which in one embodiment is web-based, that gathers and delivers a diverse amount of job-related information to persons who would otherwise require resort to several different reports or computer applications.

2. Description of Related Art

Vast amounts of information are associated with industries such as the cosmetic industry. Cosmetic workers must refer to several different computer or paper-based systems to gather information such as job performance statistics, progress towards job promotion, and contact information. Higher level workers must likewise refer to several different computer or paper-based systems to gather similar information as well as information useful for monitoring the progress of lower-level workers. Inefficiencies inherent in piecing together information from multiple sources may prevent workers from reaching their full potential. Further, the inefficiencies may prevent a business from effectively congratulating, motivating, and/or re-energizing workers based on their performance. In sum, shortcomings in information technology may negatively impact industries such as the cosmetic industry.

Such shortcomings are not intended to be exhaustive, but rather are among many that tend to impair the effectiveness of previously known techniques concerning the treatment of job-related information. Other noteworthy problems may also exist; however, those mentioned here are sufficient to demonstrate that a significant need exists for the techniques described and claimed here.

### SUMMARY OF THE INVENTION

The techniques described here are applicable to a vast number of applications, including but not limited to applications involving the computerized distribution of information to and among persons, such as workers within the cosmetic industry.

Embodiments of this disclosure alleviate difficulties associated with users having to search many locations in order to get the right job-related information at the right time. With the techniques described here, users will not have to guess about what to do next in terms of obtaining key information. In different embodiments, a user may track his or her progress, see rewards, and be educated on next steps, next actions, and next successes. The techniques can grow along with each worker as he or she grows a business.

Embodiments of this disclosure help higher-level workers know all of the right information about a particular job unit at the right time. A supervisor need not search for star performers or miss a chance to motivate and congratulate workers based on particular events. A supervisor may be able to visualize success by seeing pertinent information relating to that success. In this way, different embodiments may be thought of as an all-in-one formula to congratulate, motivate, re-energize and celebrate with, for example, a team, a unit, or area members using just one tool.

In one embodiment, the invention involves a computerized method for providing information to a user and for allowing electronic communication between the user and selected workers. A list of action items for selectable workers is provided, the listing of action items identifying actionable events according to a plurality of categories. A list of financial information for selectable workers is provided. A list of personal information for selectable workers is provided. A pre-defined electronic communication from the user to selectable workers is generated, based on the action items, financial information, or personal information.

In other embodiments, the plurality of categories may include a congratulate, motivate, re-energize, or celebrate category. The congratulate category may identify actionable events exceeding one or more pre-defined goals. The electronic communication may be pre-defined to congratulate one or more workers who have exceeded those one or more pre-defined goals. The motivate category may identify actionable events within a pre-define range of one or more pre-defined goals. The electronic communication may be pre-defined to motivate one or more workers to reach those one or more pre-defined goals. The re-energize category may identify actionable events below one or more pre-defined goals. The electronic communication may be pre-defined to motivate one or more workers to reach or exceed those one or more pre-defined goals. The celebrate category may identify a worker birthday or anniversary. The electronic communication may be pre-defined to celebrate that birthday or anniversary. The listing of action items may be sorted according to category or according to worker. The financial information may include one or more financial summaries or an identification of order status. The method may also include providing a listing of pre-defined reports that display information based on the action items, financial information, or personal information. The content of one or more of any of the lists may be modified according to a job title of the user. Each step of the method may be performed by a single computer application, which may include an Internet-based application executable at least in part on a computer browser. The method may also include providing a listing of summary information based on the action items, financial information, or personal information.

In another embodiment, the invention involves a computer readable medium comprising computer executable instructions. The instructions include: (a) providing a list of action items for selectable workers, the listing of action items identifying actionable events according to a plurality of categories; (b) providing a list of financial information for selectable workers; (c) providing a list of personal information for selectable workers; and (d) generating a pre-defined electronic communication from the user to selectable workers based on the action items, financial information, or personal information.

As used herein, “personal information” refers to contact information such as, but not limited to, names, addresses, telephone numbers, e-mail addresses, web sites, and the like. “Personal information” also encompasses information related to birthdays, anniversaries, family details (e.g., information about family members), and other personal details or notes that maybe entered by, e.g., a user, worker, or an application manager.

As used herein, “worker” should not be taken to refer to any specific employment relationship but instead refers generally to any person with some type of working relationship with another; the term therefore encompasses employees, agents, individual contractors, consultants, members, etc. In a broad sense, a worker may also refer to an entity that has a working relationship with another.

As used herein, a “single computer application” refers to a single program or suite of integrated programs and is meant to distinguish, generally, from several separate, disparate computer programs or sources of information.

As used herein, a “computer readable medium” has its ordinary meaning and includes, but is no way limited to, media such as any memory device, a hard drive, a CD, a DVD, a flash device, a floppy disk, a tape, or a file resident on a server or other storage. As used herein, “computer” should be interpreted broadly as is not limited to traditional personal computers or laptops. For instance, the term encompasses any computing device such as, but not limited to, personal digital assistants, portable e-mail devices, other handheld devices, pagers, cell phones, or the like.

Other features and associated advantages will become apparent to those of ordinary skill in the art with reference to the following detailed description of example embodiments in connection with the drawings described below.

### BRIEF DESCRIPTION OF THE DRAWINGS

These drawings form part of this document and are included to demonstrate certain aspects of the invention. The drawings do not limit the invention but simply offer examples.

FIGS. 1A-1E are screen shots of information tabs arranged according to job title, in accordance with embodiments of the invention.

FIGS. 2A-2F are screenshots that can be associated with an Action Items tab, in accordance with embodiments of the invention.

FIGS. 3A-3H are screenshots that can be associated with an Production tab, in accordance with embodiments of the invention.

FIG. 4 is a screenshot that can be associated with a Members tab, in accordance with embodiments of the invention.

FIG. 5 is a screenshot that can be associated with a Report tab, in accordance with embodiments of the invention.

FIG. 6 is a screenshot that can be associated with an E-card tab, in accordance with embodiments of the invention.

FIG. 7 is a screenshot that can be associated with an At a Glance tab, in accordance with embodiments of the invention.

### DESCRIPTION OF ILLUSTRATIVE EMBODIMENTS

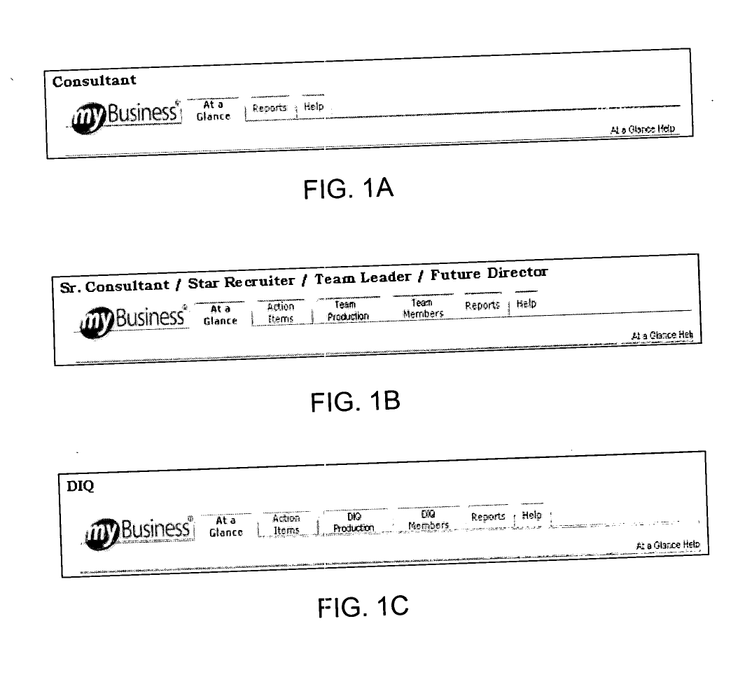

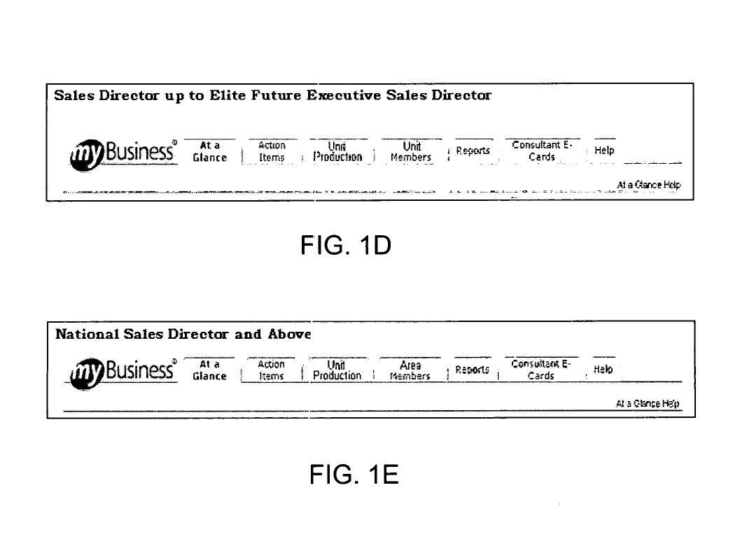

In one embodiment, computerized techniques for distributing information to and among persons may be achieved in a web-based application. In illustrated embodiments, the application is called myBusiness™, which is particularly suited for persons associated with Mary Kay Inc., although it is not so-limited to name or use. Users may log onto the application, which customizes its display based on the level of the user within the organization, or according to job title. In one embodiment, the customized display may utilize different “tabs” to show different functionality modules available to the particular user. FIGS. 1A-1E illustrate these concepts.

In FIGS. 1A-1E, different tabs are presented to users depending on their level within a company. FIG. 1A is directed to persons whose title is “consultant.” The consultant is presented with three tabs—At a Glance, Reports, and Help. FIG. 1B is directed to persons whose title is “senior consultant,” “star recruiter,” “team leader,” or “future director.” These positions are presented with six tabs—At a Glance, Action Items, Team Production, Team Members, Reports, and Help. FIG. 1C is directed to persons whose title is “director in qualification (DIQ).” The DIQ is presented with six tabs—At a Glance, Action Items, DIQ Production, DIQ Members, Reports, and Help. FIG. 1D is directed to persons whose title is “sales director” up to those whose title is “elite future executive sales director.” These positions are presented with six tabs—At a Glance, Action Items, Unit Production, Unit Members, Reports, Consultant E-cards, and Help. FIG. 1E is directed to persons whose title is “national sales director” or higher positions. These positions are presented with six tabs—At a Glance, Action Items, Unit Production, Area Members, Reports, Consultant E-cards, and Help.

The specific tabs and job titles of FIGS. 1A-1E are examples only, and those having ordinary skill in the art will readily appreciate that the functionality underlying different tabs need not be arranged the same way. For example, functionality of different tabs may be consolidated, further separated, omitted, or the like to achieve an application suited to a particular line of business and/or to particular workers within an organization. Features from one tab may also be used in other tabs. Further, an interface other than one simulating tabs may be utilized. Keeping in mind that the illustrated embodiments are examples only, the functionality of each illustrated tab will now be presented.

Action Items:

One or more categories of users may be presented with a tab for Action Items. In the embodiments illustrated at FIGS. 1A-1E, senior consultants and above have an Action Items tab. In general, this tab may present actionable items for the user, or others associated with the user (e.g., persons being supervised by the user). Actionable items may be broken down by category or by individual. Both views (by category and by individual) may list worker (e.g., consultant) names along with all or a selection of their action items. As discussed more below, embodiments of the Action Items tab may accomplish one or more of the following: automated analysis of information presented as Congratulate, Motivate, and Re-energize; link to a person's profile; viewing of a person's birthday and anniversary (personal or work); and integrate with e-cards or other communications.

View by Category

In one embodiment, the Action Items tab default view is separated into four categories: Congratulate, Motivate, Re-energize, and Celebrate. In other embodiments, more or fewer categories may be present. In still other embodiments, features of these categories may be combined, added to, omitted, or modified according to need.

The Congratulate category acts to provide information concerning new workers (e.g., congratulations for joining us) or pre-existing workers who have achieved a pre-defined goal. Pre-defined goals may vary according to industry. In embodiments involving sales, a pre-defined goal may entail the sale of a certain quantity or dollar amount of goods within a particular time frame. In other embodiments, goals may entail some measure of positive customer feedback, positive worker feedback, low merchandise return rates, increase in sales from a previous period, sales within a new region, obtaining a new account or customer, obtaining mention in the press, etc.

Goals may be defined by individual users for themselves or by other workers (e.g., by a person having a higher job title). Goals may be permanent or temporary. For example, in one embodiment, a pre-defined goal may be established that represents a sales contest of limited duration. In such an embodiment, congratulations may be in order (and hence, listed under the Congratulate category) for the workers who are winning the contest or otherwise doing well.

As will be discussed more below, the Congratulate category and other categories or items may include a link or other readily-available means to distribute an electronic card “e-card”), e-mail, or other communication to persons who have qualified for a congratulations or other communication. For instance, if a Congratulate category identifies Person A as having recently achieved a particular sales milestone, the user may readily send Person A a congratulatory e-card. Sending the e-card may be as simple as clicking a link at or near Person A's name. The e-card may automatically be tailored for someone who has achieved the particular pre-defined goal reached by Person A. In other embodiments, the e-card or communication may be sent differently and may be customized according to desire. If an e-card or communication is appropriate for a particular person and an e-mail address is on file for that person, a quick link may be provided. In one embodiment, a select box may be provided for sending one e-mail to multiple persons for the same purpose. For instance, with one click, a supervisor may congratulate all workers who have satisfied a particular goal, and that congratulations may refer to the goal that has been achieved.

The Motivate category acts to provide information concerning workers who have come within some pre-defined level of closeness to achieving a pre-defined goal. For example, the Motivate category may identify persons who are on the cusp of achieving a career goal. Alternatively, the Motivate category may identify persons who may benefit from other types of motivation. For instance, the Motivate category may identify workers who have not placed a product order or sold a product in a pre-determined time period. Such workers may benefit from a gentle reminder or motivation to do a particular task. Activities worthy of motivation may vary according to industry. In embodiments involving sales-related information, motivation may be helpful for those about the hit a pre-defined sales goal or a pre-defined job promotion (e.g., workers who are about to advance from a lower level up to a sales director). In other embodiments, motivation may be needed for those who have experienced an isolated incidence of negative customer or other feedback or an isolated change in sales statistics—in such instances, motivation may be all that is needed to remedy a situation that, if left unchecked, could worsen.

As with the Congratulate category, the Motivate category may provide the ability to send associated e-cards, email, or other communication tailored to the motivation that has been identified.

The Re-energize category acts to provide information concerning those who have, or are about to, fall below some pre-defined goal or level, representing a potentially negative job performance. For example, the Re-energize category may identify those who have been inactive for a pre-determined period of time (e.g., a worker who has not made a sale or placed an order for merchandise in the past 3 weeks). Another example may entail a worker who, due to performance, is about to drop from a higher job position to a lower one based on performance statistics. Such a person may benefit from being identified and then gently “re-energized” so that she can get back on track. Events that are included within a Re-energize category may vary according to industry. In embodiments involving sales-related information, re-energizing events may relate to lower than expected sales performance, demotion, poor feedback, loss of a sales account or customer, or the like.

As with the other categories, the Re-energize category may provide the ability to send associated e-cards, email, or other communication tailored to the re-energizing trigger or alarm that has been identified.

The Celebrate category acts to provide information concerning personal (or select business) events worthy of celebration. In one embodiment, the Celebrate category may identify birthdays and/or wedding anniversaries so that a supervisor or other person may offer a timely kind word or e-card, email, other communication, or offer a gift, cake, plan a party, etc. The events that rise to the level of celebration may vary according to desire or industry, and as with the other categories, the Celebrate category may provide the ability to send associated e-cards, email, or other communication tailored to the event worthy of celebration.

In one embodiment, events or alerts appearing under any category may be linked to a corresponding rule or guideline of the organization to provide further explanation. For example, if a Congratulate event appears for Person A's achieving a new job title, a link may be offered to explain the requirements for achieving that new job title. Likewise, if Person A is in danger of a demotion, a link may be provided to explain what job performance would justify such a demotion under present company rules.

In other embodiments, different helpful links may be provided. For example, the Motivate category may include links to sample conversations or conversation starters to help supervisors effectively convey needed information if done via telephone or in person. Pre-approved sample conversations or conversation starters may ensure that the proper information is being conveyed without running any undue legal risks (i.e., it may ensure that supervisors avoid saying something that could be misconstrued or misinterpreted by a worker).

In different embodiments, the categories described above may be filtered according to different workers or work groupings. For example, the categories may be filtered to only show category events for the Northern Sales Division or the like. Different groupings may be pre-defined according to custom or need. The filtering process may be done by any technique known in the art including, but not limited to, the use of drop-down menus. In illustrated embodiments, senior consultants, star recruiters, team leaders, future directors, DIQ, and Directors may not have a drop down for certain filtering. The Action Items category may, instead, contain information about their own team, DIQ unit, or Unit only as appropriate. For example, team leaders may see team members, DIQ may see their DIQ unit, and Directors may see their personal unit.

Formatting, arrangement, and other features of the categories outlined above can be customized so that even additional information is provided. In one embodiment, categories can be presented in short or expanded view modes. Short mode may hide entries, while an expanded mode may show more detail accessed by clicking a “+” or other indication. Drop down selections or other techniques known in the art can also be used to streamline the presentation of information as desired.

In one embodiment, names may be linked to profiles or other information and/or statistics.

View by Individual

In another embodiment, the Action Items tab view is organized by name rather than category. Names may be listed in alphabetical order. Although the view, and therefore arrangement, is different, this embodiment may display the same content as described above.

Under each name may be a list of alerts associated with him or her. Embodiments using this “view by individual” arrangement may be particularly well suited for preparing for meetings in which one or more persons will need to be addressed. Likewise, when a supervisor is speaking to a worker on the phone, that worker's Action Items may be quickly pulled up on screen to assist the supervisor make pertinent comments about the worker's action items or performance.

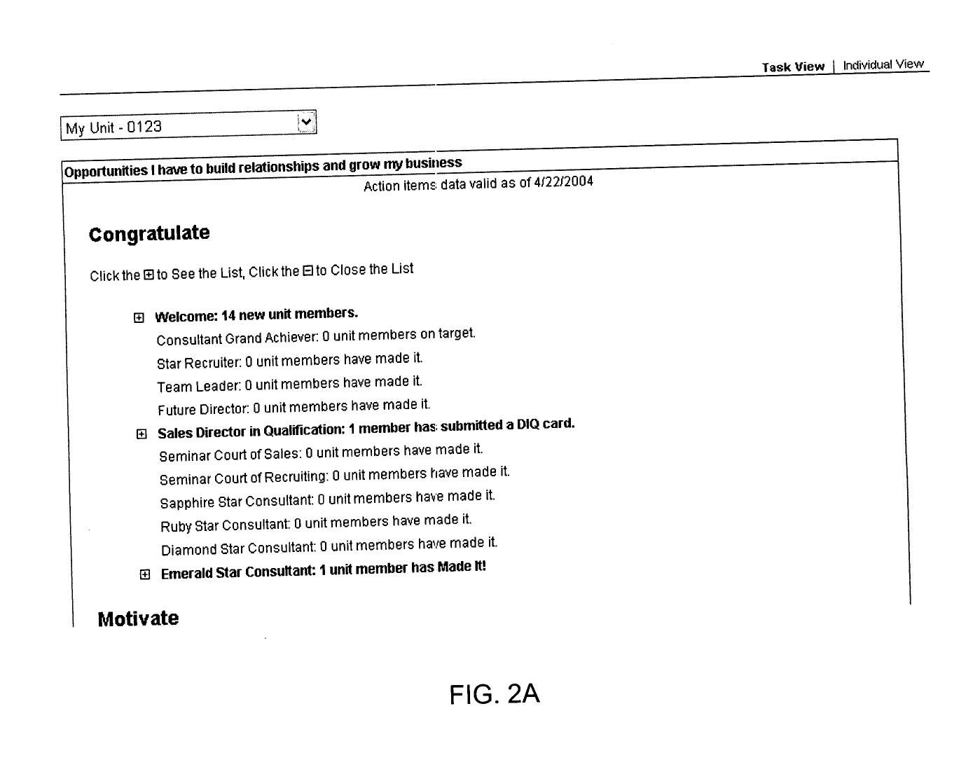

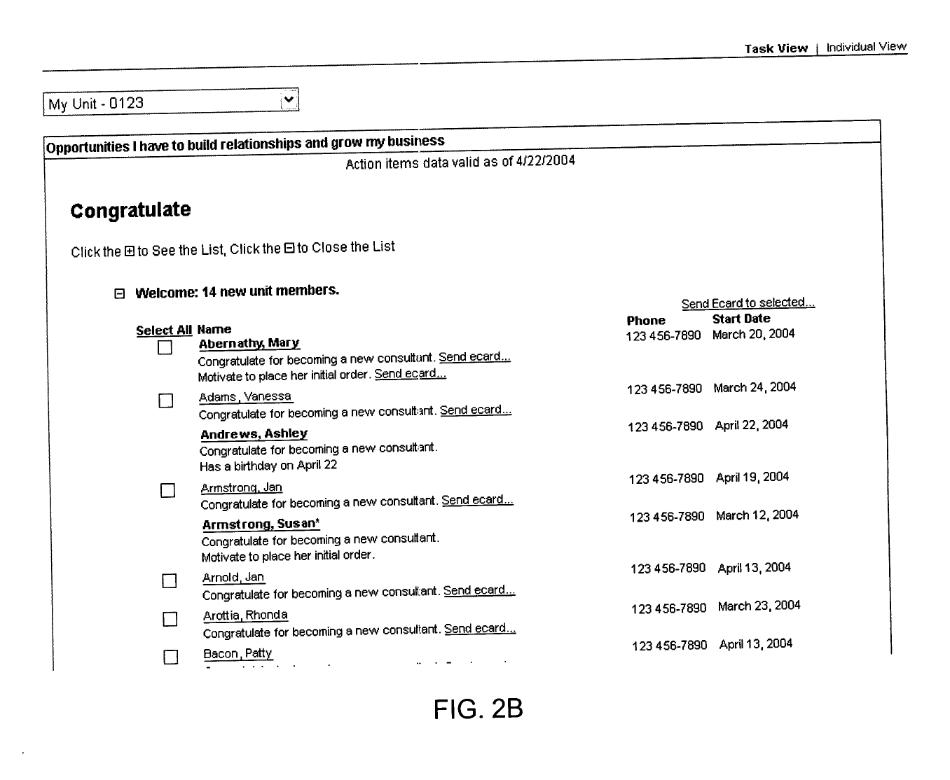

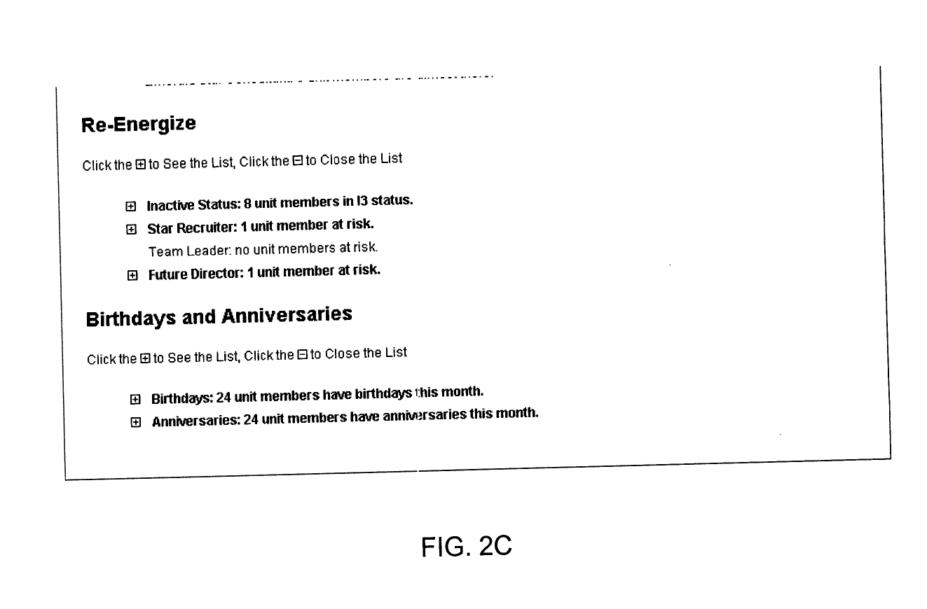

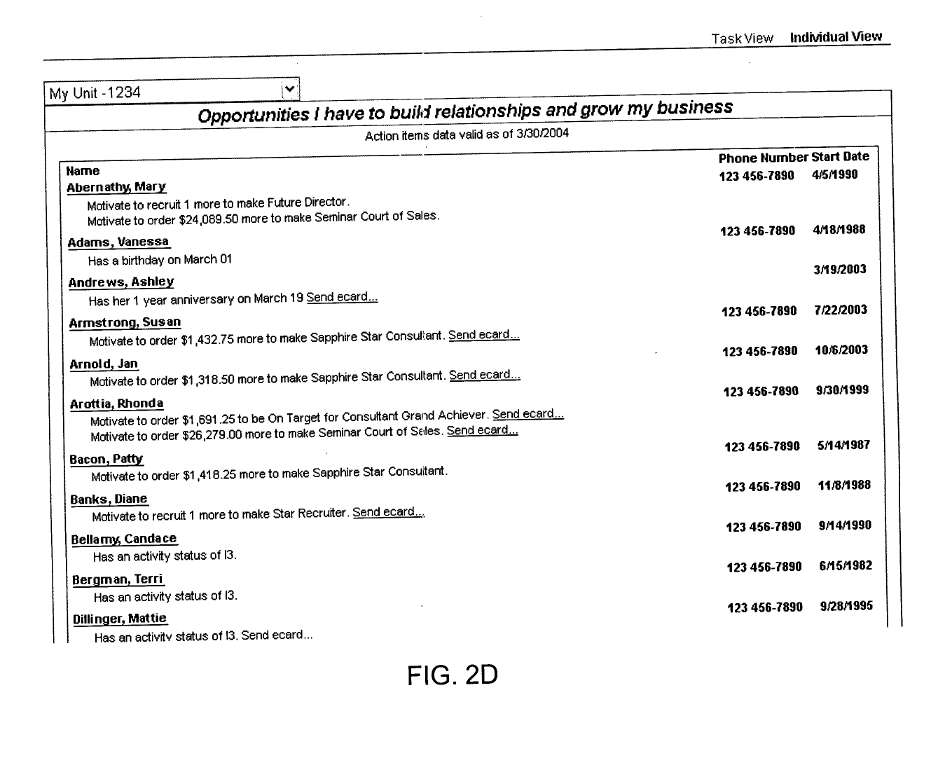

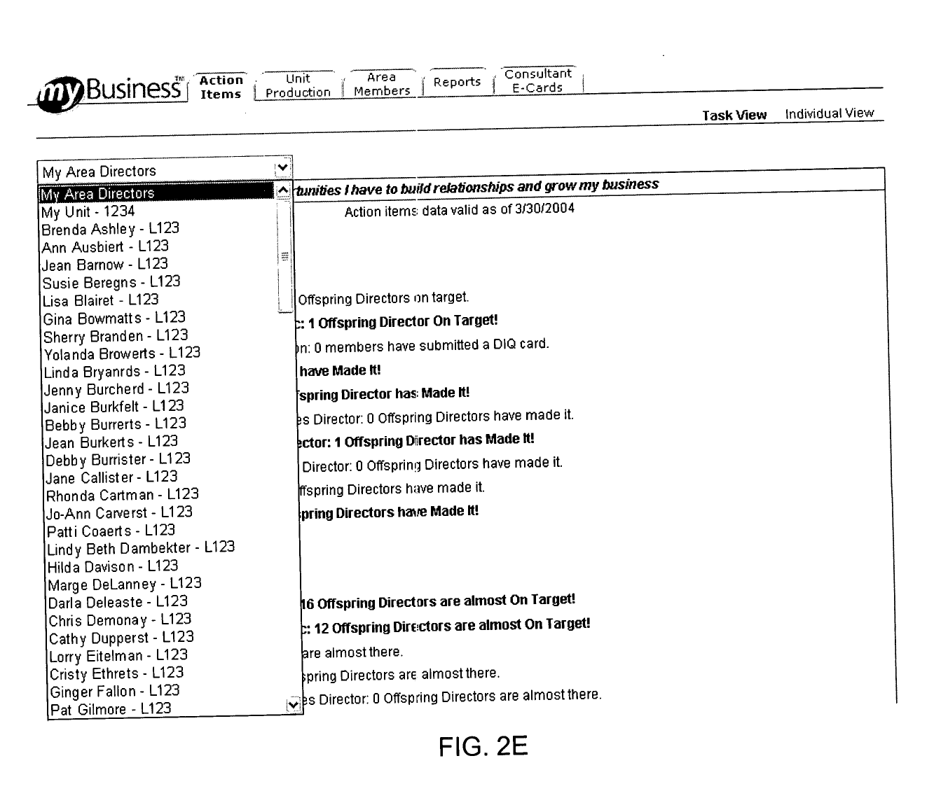

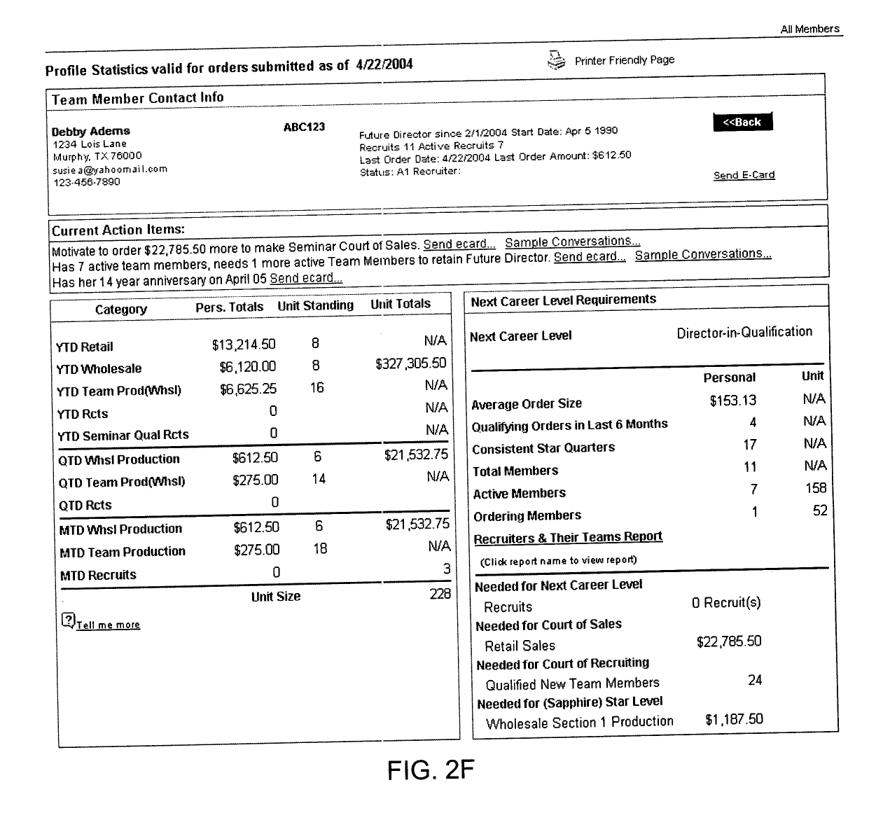

FIGS. 2A-2F illustrate aspects of the Action Items tab. The screenshot of FIG. 2A shows a default Action Items tab view. As shown in the upper right, a task view is active rather than an individual view. The upper left of the screen shows the filtering that is active—here, action items are shown for the user's “Unit,” which is a business division in the cosmetic industry as practiced by Mary Kay Inc. At the top center, the date is listed showing how current the displayed data is. Under the “Congratulate” heading, one can see instructions for expanding and collapsing the category view. In FIG. 2A, congratulations are in order for 14 new unit members, and further information about those new unit members may be displayed by pressing the “+” sign.

FIG. 2B illustrates an example view of the Congratulate category if the “+” sign is pressed. The name of each new unit member is given, which links to his or her work profile (showing pertinent job statistics such as sales performance). The user may click the “Send Ecard to Selected” link to send an e-card, email, or other communication to a person qualified for congratulations. Under each name may be listed all action items associated with that person, regardless of the category of action item. For example, under the name of Teri Bloomberg, there is not only a “congratulate” entry, but also a “motivate” entry. In this embodiment, a significant amount of information about a person may be provided in a single glance.

Referring again to FIG. 2A: associated with the unit member congratulations entry (identifying 14 new members) is general information about different levels achieved by any unit member. As shown, no unit members have reached the achiever status or other positions listed. Shown also in FIG. 2A is similar information (along with similar functionality) for two additional congratulation entries—one dealing with a sales DIQ and the other with an emerald star consultant.

FIG. 2C is a screenshot showing the Re-energize and Celebrate categories. In the Re-energize category, 8 unit members are identified as being inactive. Additional information may be revealed by expanding the associated view by pressing the “+.” Also shown is that one star recruiter and one future director are at risk. For example, those workers may be at risk of demotion or falling below a pre-determined requirement. In the Celebrate category, 24 unit members have birthdays for the given month, and 24 have anniversaries. Expanding either item reveals names, links to profiles, and the ability to send appropriate communications or cards.

FIG. 2D is a screenshot showing information similar to that in FIGS. 2A-2C, but arranged according to individual instead of by category. As seen in the upper right of FIG. 2D, individual view is selected instead of task view. Beside each name, a phone number and start date are provided. In other embodiments, different information about each person may be listed. Each individual is sorted by last name, and the list is filtered to only show the user's own “Unit” as shown in the upper right-hand drop-down menu.

FIG. 2E illustrates example selections for filtering an Action Items tab. For example, a user may view entries according to different job positions, divisions, or by individuals. Different filtering options may be employed according to the job title of the user. For example, a lower level worker may have few filtering options while a higher level worker may filter according to any group or division equal to, or below, his or her position. Any different form of grouping may be employed, and the groupings may be customized according to need. In different embodiments, the filtering shown in FIG. 2E may be applied to any other tab discussed here. Alternatively, such filtering may be used with individual features within a given tab.

FIG. 2F shows an example screenshot that may appear when a user clicks a name within the Action Items tab or other tab described here. Information that may be displayed includes: contact information, person identification number (“A98573”), job title and associated information, action items, financial information, and career level information. Links may be provided to explain the listed information or so that additional information may be obtained. E-cards or other communications associated with any category of information may be sent to the person being shown. The information shown in FIG. 2F may be customized according to the relative position of the user and the person whose name has been clicked. For example, a lower level worker may be limited to seeing only general information about a higher-level worker while the highest level of worker may see every available field of information concerning a lower level worker. The type and amount of information available to different levels of workers may be programmed as needed or desired. Security levels for different types of information may be put in place. In one embodiment, certain fields of information may require a password or other form of clearance before they can be viewed.

Team/DIQ/Unit Production:

One or more categories of users may be presented with a tab for production information. Production information concerns different categories of financial-related information. In the embodiments illustrated at FIGS. 1A-1E, senior consultants through future directors have a “Team” production tab. DIQ workers have a tab for “DIQ” production. Sales directors through future executive sales directors and national sales director and above have a tab for “Unit” production. These different categories of production may correspond to the type of production associated with the user's job title.

As discussed more below, some advantageous features that may be displayed within a Production tab include, but are not limited to: financial information of a unit, division or other grouping on one page, summary financial totals, an identification of order status, and the ability to send appropriate e-cards or other communication to those identified in a Production tab.

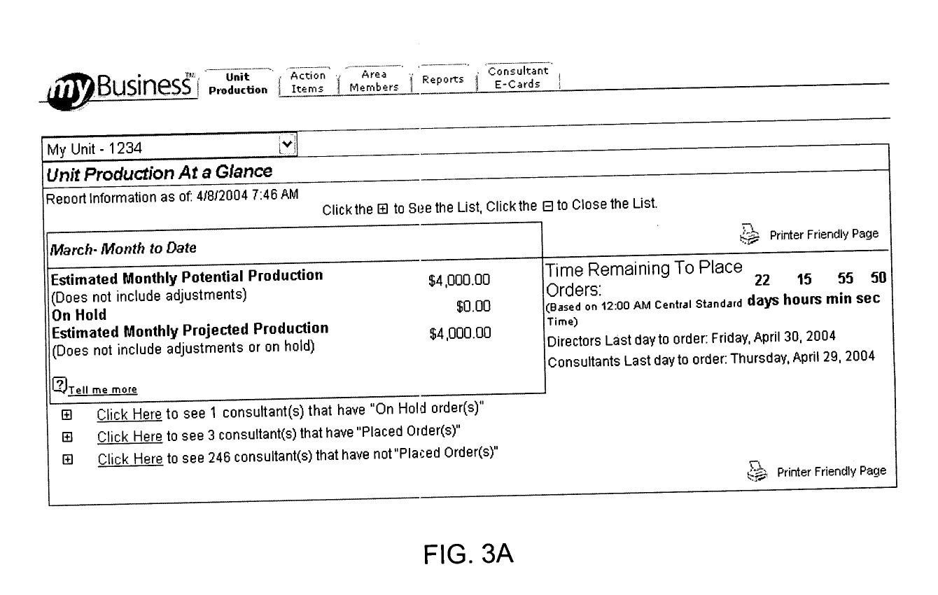

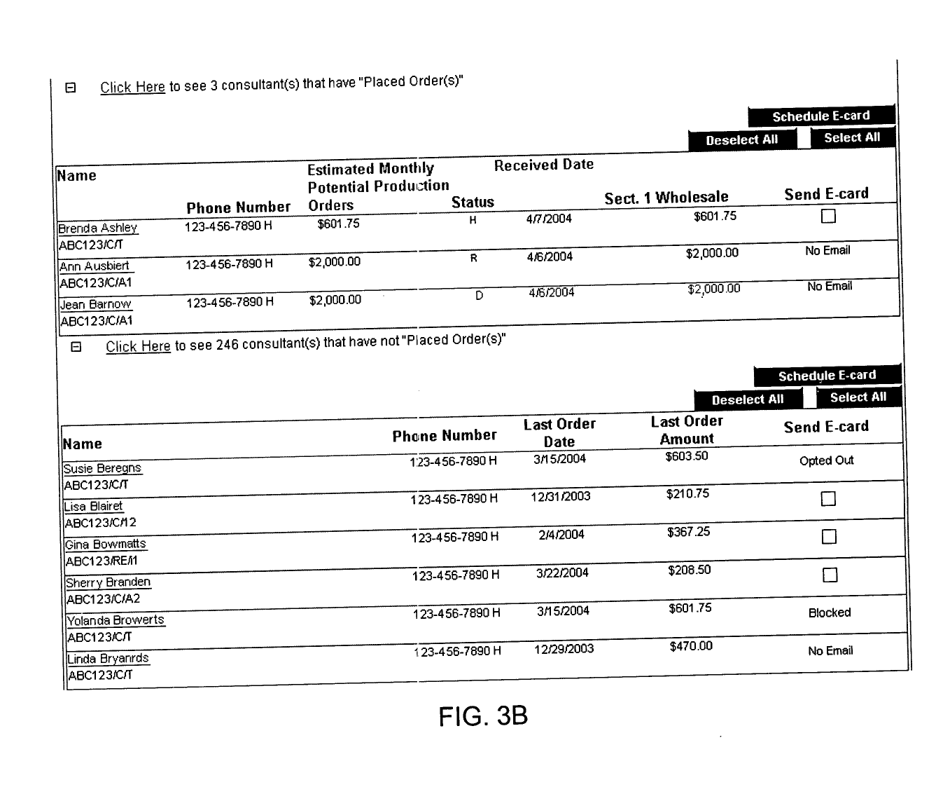

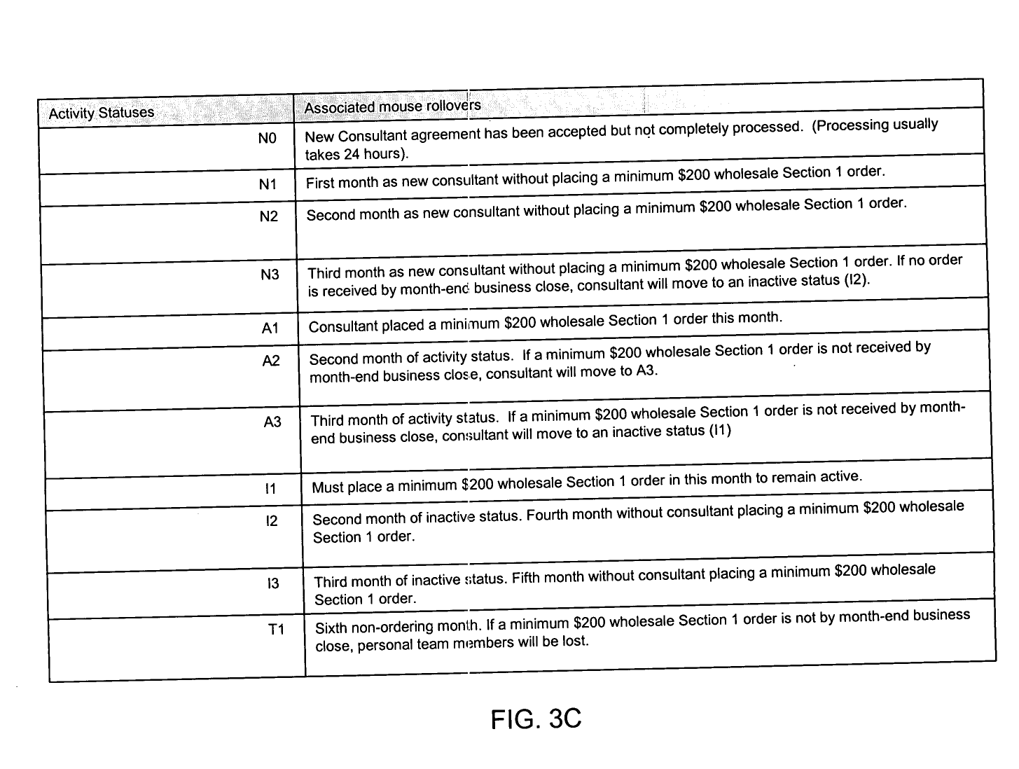

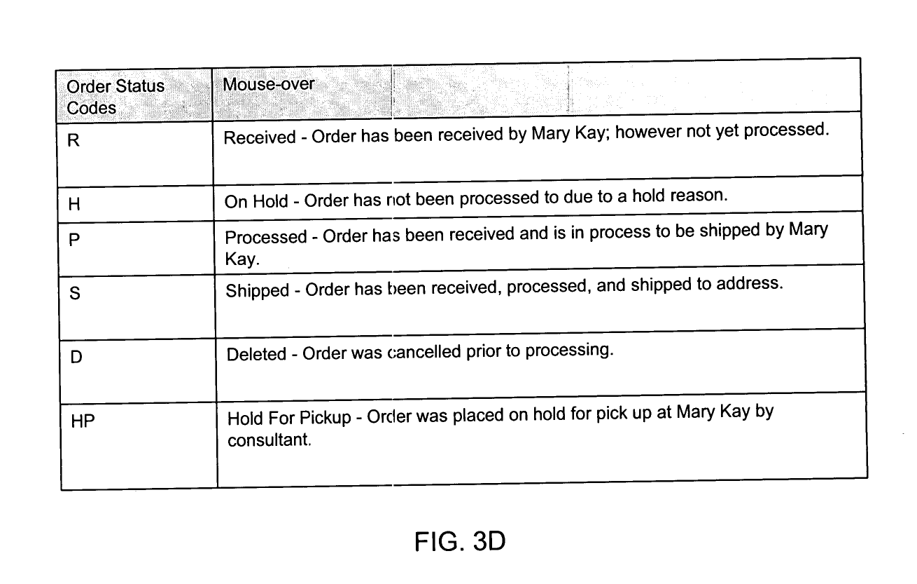

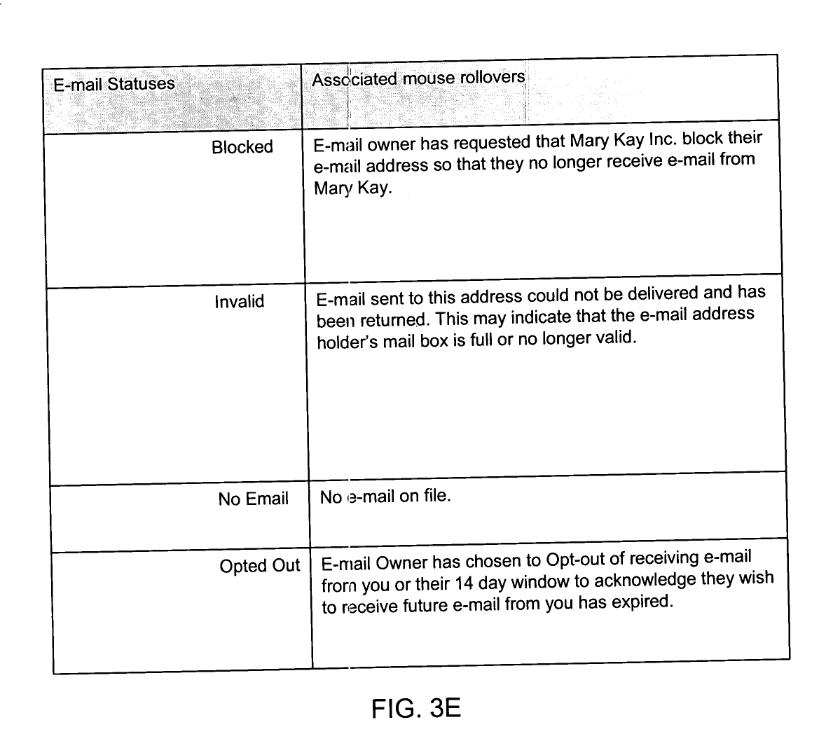

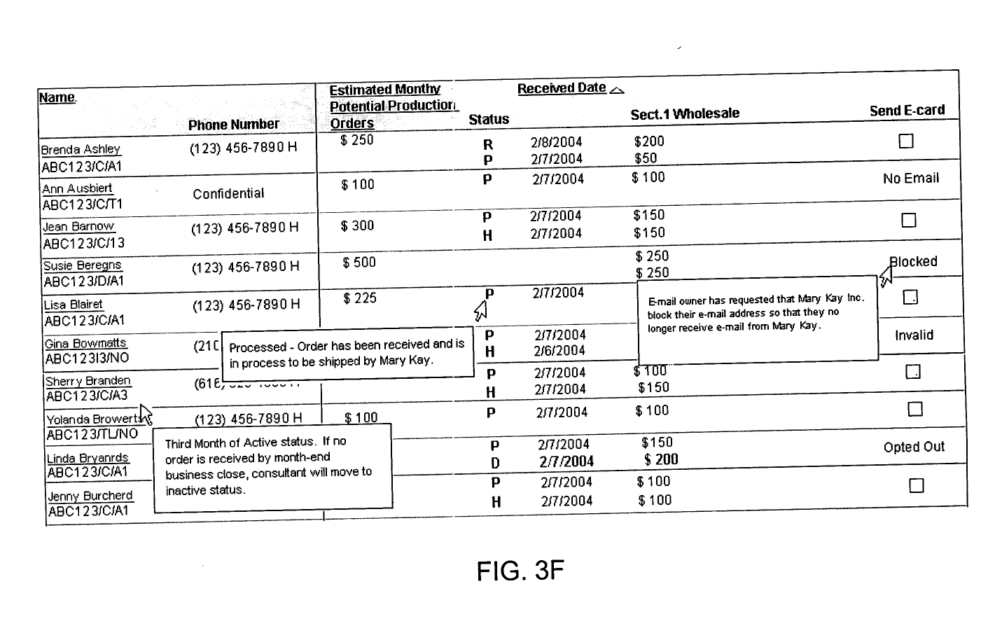

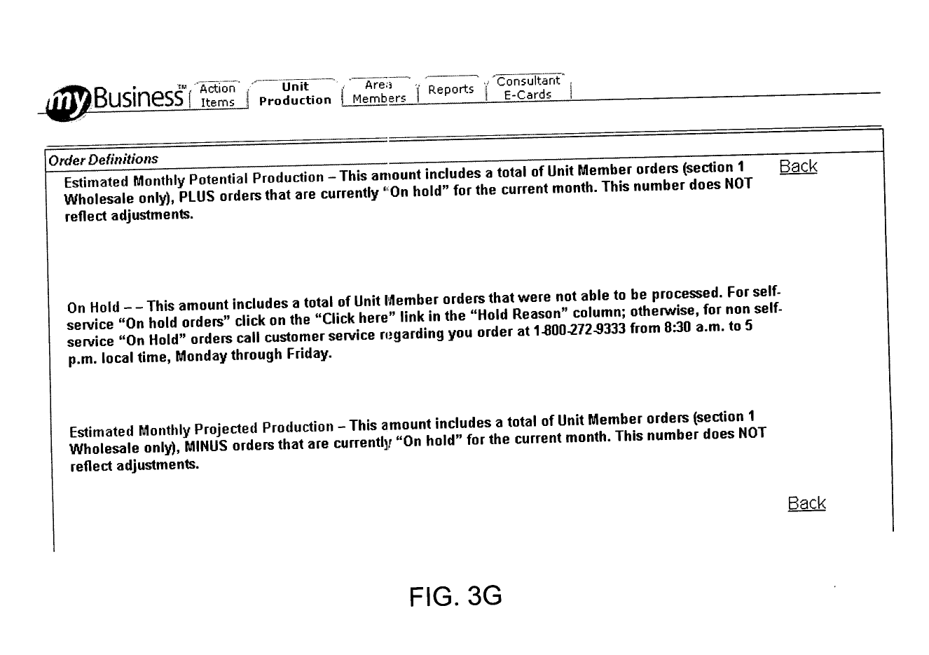

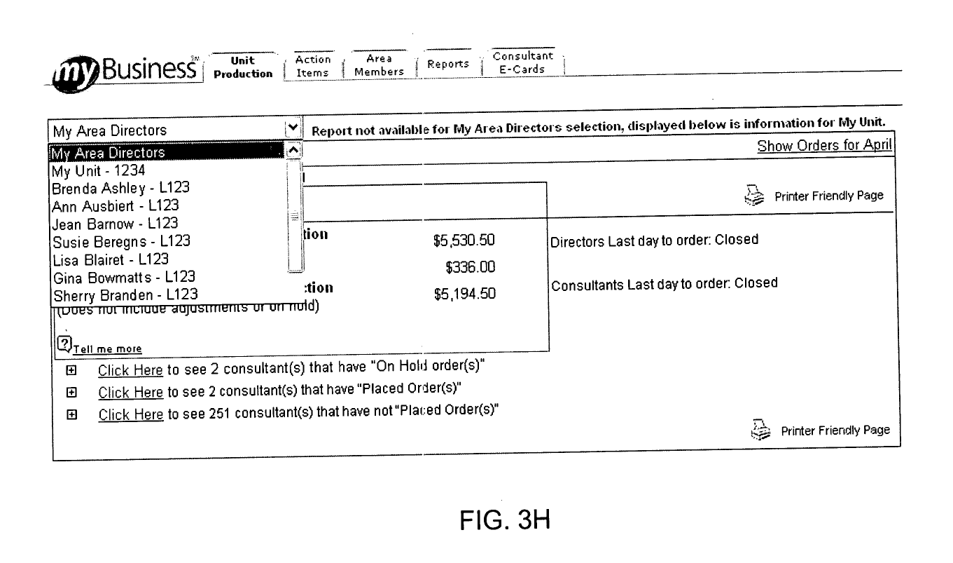

In one embodiment, the Production tab may include reminder information for ordering deadlines. In the illustrated embodiment of FIG. 3A, for example, a user is presented with the amount of time remaining until month end to place a merchandise order. In FIG. 3A, the time remaining is provided in days, hours, minutes, and seconds. In other embodiments, the amount of time may be for a different event other than ordering, and the amount of time may be broken into different increments. Also, as shown, certain deadlines may be different according to job title, which is noted in the window. In FIG. 3A, directors and consultants have different ordering deadlines.

In one embodiment, the Production tab may include financial summary information. In the illustrated embodiment of FIG. 3A, the summary information includes (a) estimated monthly potential production (not including adjustments), (b) an “on hold” amount, and (c) an estimated monthly potential production (not including adjustments or on hold). In FIG. 3A, (a) is the top summary value of $4000, (b) is the middle entry of $0, and (c) is the lower summary value of $4000. The (a) value in this embodiment includes all orders including on-line and mail-in orders. The (b) value represents orders on hold for any reason. The (c) value is given by (a)-(b). FIG. 3G, discussed below, offers definitions for the financial summary fields shown in FIG. 3A. In other embodiments, any other summary or raw financial data may be presented for any time frame desired. The information presented may be customized by users or by another.

In one embodiment, the financial summary information shown in FIG. 3A may provide for an end of month (or other period) transition period. A transition period may be useful to show an arbitrary number of days (in one embodiment, up to 10 and typically about 2) after month end and into a new calendar month where the previous month's financial information may still be displayed. During this period, divisions within the company may be reconciling and getting orders in. During this period, the previous month's financial data may be displayed as previous month's orders are still coming in. However the Production tab may still allow a person to view the new calendar month, e.g., through an appropriate link. Once the transition period has ended, the new calendar month may be displayed and the link or other viewing mechanism does not display.

In one embodiment, the Production tab may include one or more lists of information concerning order details. In FIG. 3A, three lists are provided: (1) consultants that have on-hold orders, (2) consultants that have placed orders, and (3) consultants that have not placed orders. In other embodiments, other lists of information concerning financials or different worker's financial progress may be given. For example, in one embodiment, a list may be provided summarizing persons who have agreements on hold or completed. In one embodiment, lists of information may include a link to provide more details, as in FIG. 3A, which provides a link entitled, “Click Here” to see the detailed information. FIG. 3B shows an example embodiment of an expanded list corresponding to consultants who have placed orders and consultants who have not placed orders.

Under each name in FIG. 3B, the person's identification number and job title code is provided, separated by a slash. Also under each name, an activity status code is provided, such as “A1” or “I2.” Example activity status codes are shown in FIG. 3C. FIG. 3B also provides an order status for workers who have placed an order, which appears under the column “Status.” Example order status codes are shown in FIG. 3D. FIG. 3B provides summary financial information such as estimated monthly potential production orders. Additionally, it categorizes such financial information according to internal categories—here, “Section 1 Wholesale,” which refers to total unit member orders containing products of a certain category.

Additionally, in this view, the user may send an e-card, e-mail, or other communication to those who are listed. As described before, the communication may be customized to correspond to the activity or event being shown. In FIG. 3B, an email status code such as “Opt Out,” “Block,” and “No Email” can be seen. FIG. 3E explains such status codes and the additional “Invalid” code. Additional, fewer, or no such codes may be employed according to different embodiments.

In FIGS. 3C-3E, different codes are referred to as mouse-over or rollover codes because in certain embodiments, it may be preferable for an explanation to appear on screen concerning codes appearing in the Production tab (or for an explanation regarding any other field to appear within a different tab). FIG. 3F shows an example embodiment, in which different codes described above may be displayed as a user's mouse rolls over the code itself. In other embodiments, such explanation may be displayed alternatively as is known in the art. For example, the display may come about after a user clicks on a question-mark icon and drags a mouse on or near the code in question.

In FIG. 3A, a “Tell me more” link appears within the financial summary section of the screen. If a user clicks that link, a screen such as FIG. 3G may be displayed. FIG. 3G offers definitions for the financial summary fields shown in FIG. 3A. More or fewer definitions or explanations may be provided according to need or desire.

FIG. 3H shows that information presented in the Production tab may be filtered using drop down menus or alternative techniques known in the art. As shown in FIG. 3H, the information can be displayed corresponding to individual workers or different groupings. Groupings may be customized according to need.

As those having ordinary skill in the art will appreciate additional or less information, different formatting, and/or different arrangement of information may be presented in the Production tab. For example, a page may be devoted to summarizing order statuses or new agreements with customers or others. Information may be sorted according to column, date, etc. Additional date information may be provided so that workers may create pertinent timelines or understand order histories in more detail. Additional help sections or functionality may be added. A frequently asked question (FAQ) section may be included. Forum boards may be established to discuss financial information or pose questions or general discussion. A terms of use section may be added. Again, other similar features will be apparent to those having ordinary skill in the art with the benefit of this disclosure.

Team/DIQ/Unit/Area Members:

One or more categories of users may be presented with a tab for personal information. In the embodiments illustrated at FIGS. 1A-1E, senior consultants through future directors have a “Team Members” tab. DIQ workers have a tab for “DIQ Members” production. Sales directors through future executive sales directors have a tab for “Unit Members.” National sales director and above have a tab for “Area Members.” These different categories of member information may correspond to the type of personal information associated with or necessary for the user's job title.

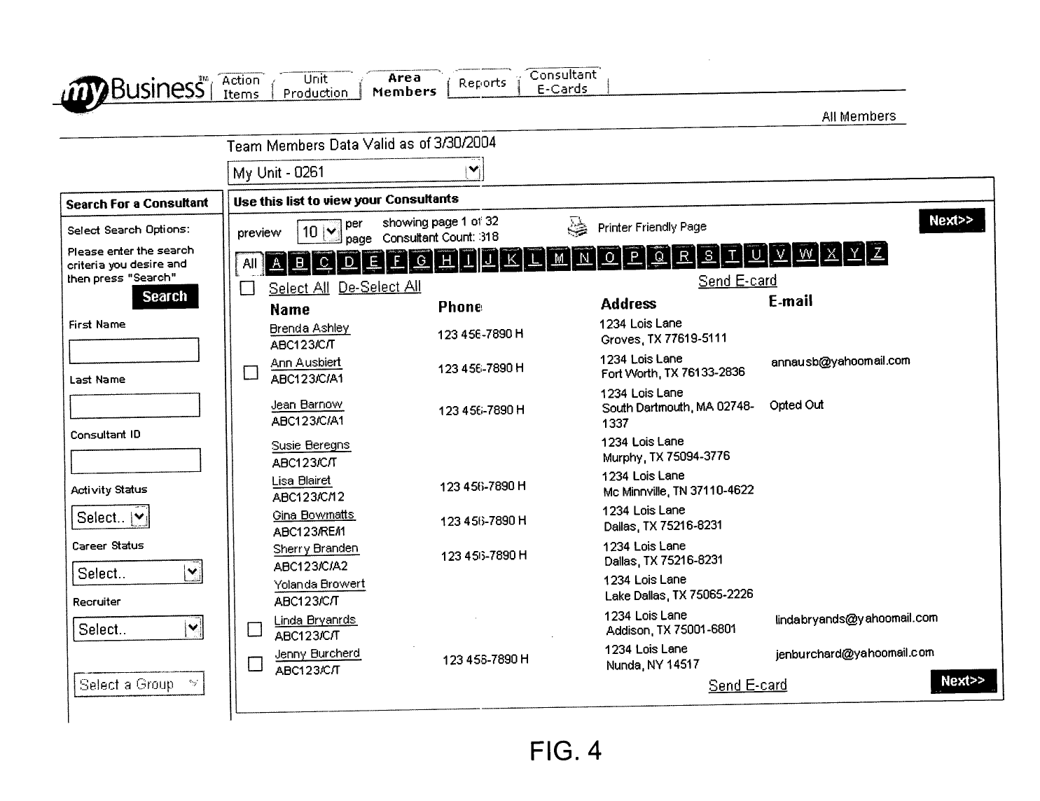

FIG. 4 shows an example embodiment of an Area Members tab, which may be configured similarly or identically to a tab for Team/DIQ/Unit Members except for the underlying personal information being available for display. In FIG. 4, worker information including identification number and job title code is provided. A person's name is a link that brings a user to a profile page for that person (see, e.g., FIG. 2F). The drop-down menu at the upper left allows a user to filter according to different groupings as desired. The ability to send an e-card, e-mail, or other communication is provided individually or by group using the checkboxes next to individual's names. If an e-mail address is not available for any reason, a checkbox next to a name may not be displayed.

At the left of FIG. 4, a search window is provided that allows a user to search for names according to various search parameters. Different, more, or fewer search parameters may be presented. Likewise, different search parameters may be defined by the user to represent particularly useful searches. Different searches and/or their results may be saved for future reference. Different e-mail groups may be defined as a result of searching for particular users, making it easy to send the proper communication to the proper group of people in a very efficient manner. Depending on connection speed, the number of results shown can be changed.

Reports:

One or more categories of users may be presented with a tab for generating or displaying reports. In the embodiments illustrated at FIGS. 1A-1E, all workers have access to a Reports tab. In other embodiments, the ability to generate or display reports may correspond to worker's job title or to some other form of qualification.

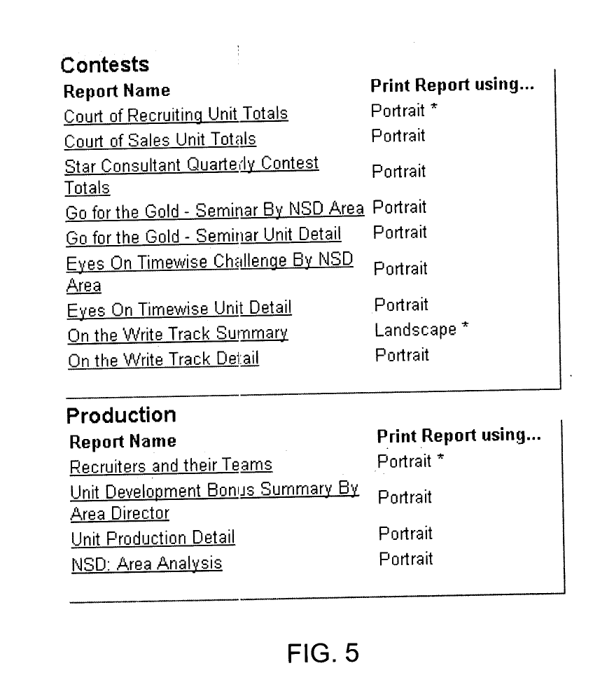

FIG. 5 shows an example embodiment of a Reports tab. In this embodiment, reports are pre-prepared and can be viewed by selecting the appropriate link. This embodiment may be particularly useful within organizations where persons are familiar with a set of standard reports that have well-defined parameters. Those reports may be maintained centrally and viewed by any (or authorized) workers on the system. In the illustrated embodiment, pre-prepared reports are available concerning different sales contests as well as financial reports.

In other embodiments, reports may be more customized. For example, users may select one or more data fields, date ranges, and/or other parameters for inclusion into a custom report. The report may be formatted in a standard way or according to the desires of the user. Custom report parameters may be saved by individual users so that the same custom report can be run without having to redefine any parameters. As with other tabs, the ability to send e-cards, e-mails, or other communications to persons may be utilized within generated or displayed reports.

Consultant E-Cards:

One or more categories of users may be presented with a tab for generating e-cards, e-mails, or other communications. In the embodiments illustrated at FIGS. 1A-1E, Sales directors and above have a dedicated tab for Consultant E-cards. Other users, however, may have the same or similar functionality through links within any other tab. For example, e-cards may be sent through an Action Items tab, a Production tab, a Member tab, a Report tab, or other tabs or modules set up using the techniques of this disclosure.

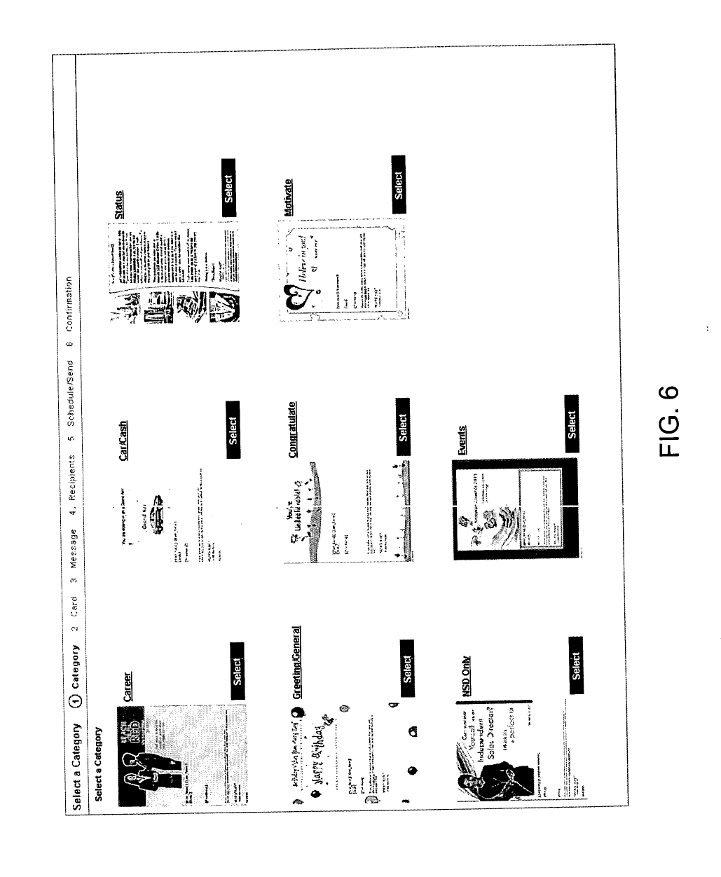

FIG. 6 shows an example embodiment of a e-cards dedicated tab or an e-card screen. As illustrated, different e-cards may be pre-prepared corresponding to different recurrent or useful themes. For example, one or more cards may correspond to congratulations or motivation, which may in turn correspond to entries within an Action Items tab. Additional e-card themes may be maintained centrally or individually so that appropriate communications can be sent efficiently to the proper person. The inventors have found that the ability to send communications that apply personally to workers can greatly boost morale and lead to better job performance. E-cards may be customized to any extent by users, and customizations may be saved for later use. The e-cards may have fields that automatically fill-in with a worker's name so that there is a custom feel to the card even if it is sent to a large group automatically or semi-automatically (i.e., after some degree of customization). E-cards may be linked to photographs to provide a further appearance of a personal touch. Other photographs or images may be linked automatically or according to algorithms. For example, if a certain sales milestone is reached, an e-card may be sent that incorporates one of many photographs earmarked for that milestone. Additional levels of customization will be apparent to those having ordinary skill in the art.

At a Glance:

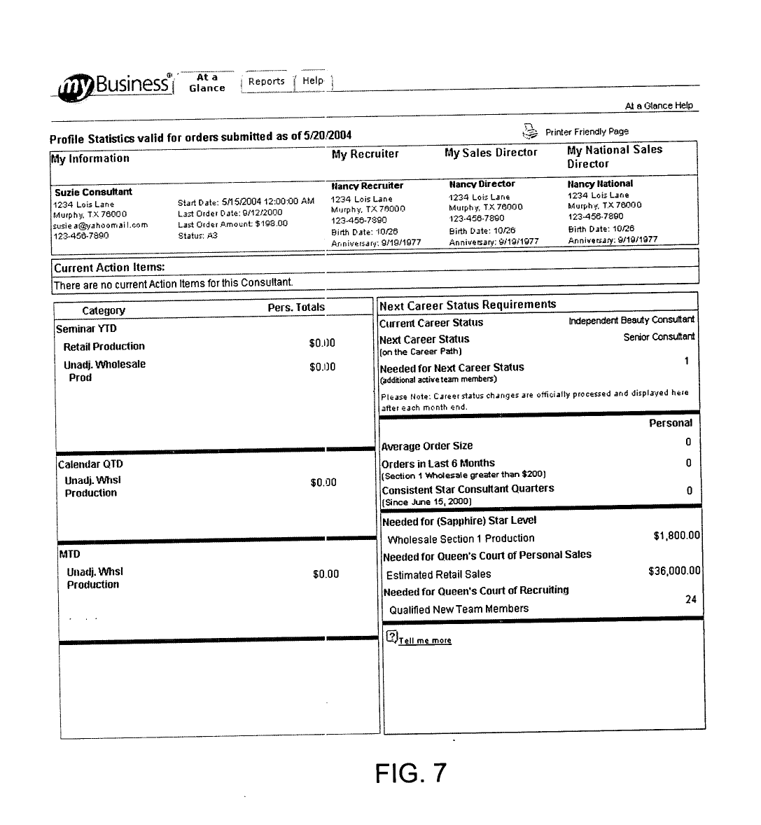

In illustrated embodiments, each user has access to a tab entitled, “At a Glance.” This tab presents one or more categories of information from the other tabs in a summarized format for quick viewing. In different embodiments, the selection and arrangement of presented information may be customized or pre-set. This tab allows users to access many types of information in one or a few views. FIG. 7 shows an example At a Glance tab that shows information such as that discussed here.

Within any tab, the arrangement of information may be customized according to need or desire so that the user is presented with a tailored information retrieval and display system. As a worker's job responsibilities change over time, he or she may need to study different types of information, which may be readily accomplished by defining different or additional fields for different tabs.

Any embodiment of this disclosure may be implemented using software techniques known in the art. A software application using the techniques of this disclosure may be programmed in any computer language or script known in the art including but not limited to BASIC, FORTRAN, PASCAL, C, C++, C#, JAVA, HTML, XML, or the like. The application may be a stand-alone application, network based, and particularly, internet based to allow easy, remote access. The application may be run on a personal computer, personal digital assistant (PDA), or any other computing mechanism. Content from the application may be pushed to one or more portable devices as is known in the art.

With the benefit of the present disclosure, those having ordinary skill in the art will comprehend that techniques claimed here and described above may be modified and applied to a number of additional, different applications, achieving the same or a similar result. For example, any information presented to a user can be presented in text and/or graphic format. For example, one or more graphs, charts, clip-art, videos, animations, hierarchy trees, etc. may be used in addition to, or instead of the text and numerical data shown in the figures and described here. The claims attached here cover all such modifications that fall within the scope and spirit of this disclosure.

### REFERENCES

Each of the following references is hereby incorporated by reference in its entirety:

U.S. Published Application 2004/0138944

U.S. Published Application 2004/0088177

U.S. Published Application 2003/0055717

U.S. Published Application 2003/0046265

U.S. Published Application 2002/0178048

U.S. Pat. No. 6,754,874

U.S. Pat. No. 6,662,164

U.S. Pat. No. 6,343,275

U.S. Pat. No. 6,310,951

U.S. Pat. No. 6,275,812

U.S. Pat. No. 5,239,460

1. A computerized method for providing information to a user and for allowing electronic communication between the user and selected workers, the method comprising:
(a) providing a list of action items for selectable workers, the listing of action items identifying actionable events according to a plurality of categories;
(b) providing a list of financial information for selectable workers;
(c) providing a list of personal information for selectable workers; and
(d) generating a pre-defined electronic communication from the user to selectable workers based on the action items, financial information, or personal information.

2. The method of claim 1, where the plurality of categories comprises a congratulate, motivate, re-energize, or celebrate category.

3. The method of claim 2, where the congratulate category identifies actionable events exceeding one or more pre-defined goals.

4. The method of claim 3, where the electronic communication is pre-defined to congratulate one or more workers who have exceeded the one or more pre-defined goals.

5. The method of claim 2, where the motivate category identifies actionable events within a pre-define range of one or more pre-defined goals.

6. The method of claim 5, where the electronic communication is pre-defined to motivate one or more workers to reach the one or more pre-defined goals.

7. The method of claim 2, where the re-energize category identifies actionable events below one or more pre-defined goals.

8. The method of claim 7, where the electronic communication is pre-defined to motivate one or more workers to reach or exceed the one or more pre-defined goals.

9. The method of claim 2, where the celebrate category identifies a worker birthday or anniversary.

10. The method of claim 9, where the electronic communication is pre-defined to celebrate the birthday or anniversary.

11. The method of claim 1, where the listing of action items is sorted according to category or according to worker.

12. The method of claim 1, where the financial information comprises one or more financial summaries or an identification of order status.

13. The method of claim 1, further comprising providing a listing of pre-defined reports that display information based on the action items, financial information, or personal information.

14. The method of claim 1, where content of one or more lists are modified according to a job title of the user.

15. The method of claim 1, wherein steps (a)-(e) are performed by a single computer application.

16. The method of claim 15, the single computer application comprising an Internet-based application executable at least in part on a computer browser.

17. The method of claim 1, further comprising providing a listing of summary information based on the action items, financial information, or personal information.

18. A computer readable medium comprising computer executable instructions, the instructions comprising:
(a) providing a list of action items for selectable workers, the listing of action items identifying actionable events according to a plurality of categories;
(b) providing a list of financial information for selectable workers;
(c) providing a list of personal information for selectable workers; and
(d) generating a pre-defined electronic communication from the user to selectable workers based on the action items, financial information, or personal information.
